(19) United States
(12) Patent Application Publication
(10) Pub. No.: US 2024/0407301 A1
(43) Pub. Date: Dec. 12, 2024

(54) TRANSMISSION UNIT

(71) Applicant: MASCHINENFABRIK BERNARD KRONE GMBH & CO. KG, Spelle (DE)

(72) Inventors: Hermann ECKSELER, Spelle (DE); Felix KALVERKAMP, Recklinghausen (DE); Christian KNIFKE, Nordwalde (DE); Sven KOPMEYER, Osnabrueck (DE); Aleksej KREKER, Westerkappeln (DE)

(73) Assignee: MASCHINENFABRIK BERNARD KRONE GMBH & CO. KG, Spelle (DE)

(21) Appl. No.: 18/673,369

(22) Filed: May 24, 2024

(30) Foreign Application Priority Data
May 26, 2023 (DE) 10 2023 113 954.1

(51) Int. Cl. A01F 15/08; A01F 15/07; A01F 15/10

(52) U.S. Cl. CPC A01F 15/085; A01F 15/07; A01F 15/106

(57) ABSTRACT

The transmission unit for a round baler includes a drive part having a drive shaft, a press roller driven part coupled to the drive part which to at least indirectly drives a pressing roller to act on a crop material, a cutting rotor driven part which at least indirectly drives a cutting rotor to convey the crop material towards a pressing chamber, and a coupling mechanism which selectively couples and decouples the drive part and the cutting rotor driven part. The coupling mechanism has a coupling gearwheel which is non-rotatably connected to the drive shaft and which is adjustable axially with respect thereto. The first coupling gearwheel is selectively drivingly coupled to the cutting rotor driven part in a coupling position and is decoupled therefrom in a release position, and is drivingly coupled to the press roller driven part both in the coupling and in the release position.

### CROSS REFERENCE TO PRIOR APPLICATIONS

Priority is claimed to German Patent Application No. DE 10 2023 113 954.1, filed May 26, 2023. The entire disclosure of said application is incorporated by reference herein.

### FIELD

The present invention relates to a transmission unit and to a round baler.

### BACKGROUND

Round balers are used in agriculture to pick up crops such as hay or straw from the ground and to press them into round crop bales, which can then be wrapped with a binding material. Cords, nets or (in the case of, for example, grass) films can be used as binding material, whereby films can also be applied outside the round baler in a separate bale wrapping device. The crop is first picked up from the ground (normally by a pick-up) and then transferred to a conveyor rotor or cutting rotor, which conveys the crop via a feed channel to the bale formation chamber or press chamber, in which the actual baling takes place. Press elements there act on the crop, which also act as conveying elements, so as to generate a circulating movement of the crop. In round balers with a variable chamber, the effective size of the chamber is adapted to the increasing amount of crop, with at least one endlessly rotating press element defining a predominant part of the press chamber. The press element can, for example, be designed as a bar chain conveyor with circulating chains and bars running between them or have one or normally several pressing belts or a pressing strap. The press element is guided by a plurality of guide rollers, at least one of which can be driven. Where the feed channel opens into the press chamber, there is often a pair of rollers which define a feed gap for the crop. At least one of these rollers can be driven.

It is known in the state of the art to couple a drive power into a transfer gearbox, which splits this drive power and transmits it to the press element, to at least one feed element (feed rotor, cutting rotor and/or pick-up) and possibly to one of the aforementioned rollers. The drive power can, for example, be transmitted via a shaft with a corresponding coupling from a tractor that pulls the round baler. This type of distribution and transmission of the drive power is efficient, but can lead to problems if one of the driven components is to be moved independently. The feed element can in particular become blocked, either because too much crop has been picked up or because a foreign object such as a stone has been pulled in. At least the feed element must in this case first be stopped and then moved backwards a little, i.e., in the opposite direction to the normal drive direction. If the feed element is coupled to the press element via the transfer gearbox, however, the press element must also be moved. The press belt including all guide rollers would, for example, have to be moved backwards. While the feed element (feed rotor or similar) could be moved manually on its own, this is practically impossible if there is a mechanical coupling to the press element. Even if the feed element could instead be moved backwards by a motorized drive, a simultaneous backwards movement of the press element would be uneconomical and could interfere with bale formation.

### SUMMARY

An aspect of the present invention is to provide an improved system for distributing a drive torque to a press element and a feed element in a round baler which efficiently removes a crop jam.

In an embodiment the present invention provides a transmission unit for a round baler. The transmission unit includes a drive part comprising a drive shaft which is configured to couple in a drive torque, a press roller driven part which is configured to have the drive part be coupled thereto in a driving manner and to at least indirectly drive a pressing roller so as to act on a crop material in a pressing chamber, a cutting rotor driven part which is configured to at least indirectly drive a cutting rotor so as to convey the crop material towards the pressing chamber, and a coupling mechanism which is configured to selectively couple and decouple the drive part and the cutting rotor driven part. The drive shaft is rotatable about a drive shaft axis of rotation. The coupling mechanism comprises a first coupling gearwheel which is non-rotatably connected to the drive shaft and which is configured to be adjustable axially with respect thereto. The first coupling gearwheel is configured so as to be selectively drivingly coupled to the cutting rotor driven part in a coupling position and to be decoupled from the cutting rotor driven part in a release position, and to be drivingly coupled to the press roller driven part both in the coupling position and in the release position.

### BRIEF DESCRIPTION OF THE DRAWINGS

The present invention is described in greater detail below on the basis of embodiments and of the drawings in which:

FIG. 1 shows a schematized side view of a round baler according to the present invention;

FIG. 2 shows a perspective view of a transmission unit according to the present invention including a transmission housing;

FIG. 3 shows a perspective view of the transmission unit from FIG. 2 without the transmission housing;

FIG. 4 shows a front view of the transmission unit from FIG. 2 without the transmission housing in a first state;

FIG. 5 shows a front view of the transmission unit from FIG. 2 without the transmission housing in a second state; and

FIG. 6 shows a sectional view of a part of the transmission unit from FIG. 2.

### DETAILED DESCRIPTION

The present invention provides a transmission unit for a round baler with a drive part designed for coupling a drive torque, having a drive shaft rotatable about a drive shaft axis of rotation, a press element driven part, to which the drive part is coupled in a driving manner and which is provided for the purpose of at least indirectly driving a press element in order to act on harvested material in a press chamber, a feed element driven part, which is provided for the purpose of at least indirectly driving a feed element in order to feed harvested material to the press chamber, and a coupling mechanism for selectively coupling and decoupling the drive part and the feed element driven part,

The round baler, for which the transmission unit is provided, is designed for pressing agricultural crops into (round) bales. It can be self-propelled or designed to be pulled by a tractor. The agricultural crop can in particular be stalk material such as grass, straw or hay, but can also, for example, be chopped maize. The round baler has a frame that forms its basic structure and provides overall stability thereto. The running wheels of the round baler are also attached to the frame via a suitable suspension, as is a drawbar in the case of a towed design. The frame also typically has a housing that shields the internal parts, namely, a pressing device, from the outside.

The crop can be picked up by a pick-up and conveyed further towards the press chamber, for example, by a conveyor rotor. Instead of a simple conveyor rotor or in addition thereto, a cutting rotor can be provided which not only conveys the crop further, but also cuts the crop. The round baler normally has a feed channel through which the crop flow passes before it reaches the press chamber. Any movable element that serves to convey the crop towards the press chamber, i.e., in particular a conveyor rotor, a cutting rotor and/or a pick-up, is referred to here and below as a feed element.

The forming of the crop bale and thus also the actual baling process take place within the press chamber by a baling device, which can be arranged at least partially, and if necessary, also completely, within a frame. The press chamber, in which the bale is formed and the bale is pressed, can be at least partially delimited or defined by the pressing device. The pressing device has at least one press element which can be driven relative to the frame. In this context, the press element can consist of one or more components, as will be explained below. A plurality of press elements may also be provided. The respective press element acts on the crop in the press chamber and is thus significantly involved in the actual bale formation.

The transmission unit according to the present invention is mounted on the round baler or inside it when installed. The transmission unit can, for example, have a gearbox housing on which various gearbox components can be movably mounted and in which they can be accommodated in order to protect them from dirt and damage. The gearbox housing can in particular be mounted directly or indirectly on the frame of the round baler.

The transmission unit has a drive part that is designed and intended for coupling a drive torque. This means that a drive torque generated by a motor can be coupled into the transmission unit via the drive part. In the operating state, the motor is coupled to the drive part in a driving manner. The motor can be part of the round baler or, for example, be part of a tractor that pulls the round baler. In this context, the drive part need not be directly coupled to the motor, an indirect coupling via at least one other element is also possible. The drive section has a drive shaft that can be rotated about a drive shaft axis of rotation. The drive shaft can, for example, be rotatably mounted on the aforementioned gearbox housing, for example, via one or more roller bearings. The drive shaft can be designed as a single piece or consist of a plurality of rigidly connected elements. In addition to the drive shaft, the drive section can have other components. Instead of a drive part, it can also be referred to as a partial drive gearbox. The output parts discussed below can also be referred to as output partial drive.

The transmission unit also has a press element driven part to which the drive part is coupled in a driving manner and which is intended to at least indirectly drive a press element in order to act on harvested material in the pressing chamber. In the operating state, the power flow is from the drive part to the press element driven part, i.e., part of the drive power is transmitted from the drive part to the press element driven part. In this respect, the former is coupled to the latter in a driving manner. This can also be referred to as a force-transmitting or motion-transmitting coupling. When installed, the press element driven part of the transmission unit drives a press element, either directly or indirectly, via an intermediate element. The basic function of such a press element has already been explained.

The gear unit also has a feed element driven part which is intended to at least indirectly drive a feed element in order to convey harvested material to the press chamber, and also has a coupling mechanism for selectively coupling and decoupling the drive part and feed element driven part. When installed, the feed unit driven part drives a feed element, the function of which has already been explained. The connection can here to be direct or indirect. The feed element driven part is not permanently coupled to the drive part, but can be decoupled by the coupling mechanism. In the coupled state, the feed element driven part is driven by the drive part, i.e., part of the drive power is transmitted from the drive part to the feed element driven part. In the decoupled state, the feed element driven part can be moved independently of the drive part or can also be held at rest. In the assembled state, if there is a blockage in the area of the feed element, for example, a conveyor rotor, the feed element can be stopped or moved backwards manually in order to remove harvested material or foreign objects. While the feed element is moved backwards, the drive part and the press element driven part can remain stationary, i.e., they do not also need to be moved. It would also be conceivable to allow the drive section and press element driven part to continue running if, for example, a bale of crop is to be completed while the blockage is being removed.

The present invention provides that the coupling mechanism has a first coupling gearwheel which is connected to the drive shaft in a non-rotatable manner and can be adjusted axially relative thereto, as a result of which the first coupling gearwheel can be selectively coupled to the feed element driven part in a driving manner in a coupling position and decoupled therefrom in a release position, the first coupling gearwheel being coupled to the press element driven part in a driving manner both in the coupling position and in the release position. The drive shaft and the first coupling gearwheel can interact positively via guide structures that enable axial displacement but restrict or prevent tangential rotation. The drive shaft can, for example, have guide grooves in which projections of the first coupling gearwheel engage. Here and in the following, “torsion-proof” always means that the connection allows at most a limited relative rotation. This means that the connection may have a certain amount of play in the tangential direction. There can, however, be no significant play. Such a connection can in this case be described as torsionally rigid. Due to the connection, the first coupling gearwheel rotates with the drive shaft. Due to its axial mobility in relation to the drive shaft, the first coupling gear can be adjusted between a coupling position and a release position. In the coupling position, the first coupling gearwheel is drivingly coupled with the feed element driven part. A driving force and a driving torque are therefore transmitted to the feed element driven part via the drive shaft and the first coupling gearwheel. If the first coupling gearwheel is moved into the release position by being displaced axially relative to the drive shaft, it is decoupled from the feed element drive part so that the latter is also decoupled from the drive part. However, the first coupling gearwheel works together with the press element driven part in both positions. Although not absolutely necessary, the corresponding coupling can, for example, also be present in all positions between the coupling position and the release position. The drive part is in any case coupled to the press element driven part via the first coupling gearwheel in both positions. The first coupling gearwheel can, for example, interact with a gearwheel of the press element driven part, i.e., it meshes therewith. Both gearwheels can, for example, be designed as spur gears, although a bevel gear or crown gear design is also possible.

The first coupling gearwheel therefore has a dual function: it establishes the drive coupling to the press element driven part, and it establishes the coupling to the guide element driven part in the coupling position and decouples the guide element driven part from the drive part when it is in the release position. It therefore serves to distribute and transmit the drive power to the two output parts and at the same time forms an essential element of the coupling mechanism. The first coupling gearwheel in this respect combines transmission and clutch functions. These functions are provided by a single component. Compared to a gearbox in which each function is provided by a separate component, not only is the number of parts reduced, but installation space is also saved.

The feed element driven part can, for example, have a second coupling gearwheel which coaxially surrounds the drive shaft, whereby the first coupling gearwheel in the coupling position connects the second coupling gearwheel to the drive shaft in a non-rotatable manner via a positive fit with the second coupling gearwheel, while the second coupling gearwheel can rotate freely relative to the drive shaft by releasing the positive fit in the release position. The second coupling gearwheel is itself rotatably mounted on the drive shaft, i.e., it can rotate relative to the drive shaft (and vice versa) as long as there is no connection via another element. It is precisely this connection that is established by the first coupling gearwheel when it is in the coupling position. This creates a positive connection between the two coupling gearwheels, which connects the second coupling gearwheel to the first coupling gearwheel and thus also to the drive shaft in a non-rotating manner. At least one coupling gearwheel can have structures projecting in the axial direction which engage in corresponding recesses in the other coupling gearwheel. The two coupling gearwheels can in particular be connected to each other via a claw coupling. The first coupling gearwheel is arranged closer to the second coupling gearwheel in the coupling position than in the release position. If the first coupling gearwheel is moved back into the release position, the positive locking is released and the second coupling gearwheel can be rotated independently of the drive shaft. It can in particular also remain stationary while the drive shaft rotates. The second coupling gearwheel can in particular be designed as a spur gear, however, a design as a bevel gear or crown gear is also conceivable.

In an embodiment of the present invention, the transmission unit can, for example, have a gear housing for stationary arrangement on the round baler and the drive shaft can, for example, have a bearing section which is rotatably mounted on the gearbox housing and a cantilevered section, with the coupling gearwheels being arranged on the cantilevered section. The drive shaft is in this case rotatably mounted on the gearbox housing via one or more bearings, typically roller bearings. The corresponding section of the drive shaft in which forces can be transmitted between the drive shaft and the gearbox housing is referred to as the bearing section. Part of the drive shaft extends beyond the bearing section and forms a cantilevered section. The coupling gearwheels are arranged on this unsupported section. They are therefore only supported by bearings on one side when viewed along the drive shaft axis of rotation. This design facilitates assembly of the transmission unit. Since a large part of the total torque must typically be transmitted to the feed element driven part and the feed element connected thereto, it is advantageous to arrange the second coupling gearwheel interacting therewith closer to the bearing section. In other words, the second coupling gearwheel can, for example, be arranged closer to the bearing section than to the first coupling gearwheel.

The gear unit can be used to distribute the drive torque to more than one press element driven part. In a embodiment, the first coupling gearwheel can, for example, be drivingly coupled to a first press element driven part and a drive shaft gearwheel connected to the drive shaft in a non-rotatable manner can, for example, be drivingly coupled to a second press element driven part. This means that the transmission unit has a first and a second press element driven part. These can be assigned to a first and a second press element. The designations “first” and “second” are only used for differentiation and do not indicate the importance or sequence of the press elements or the press element driven parts. The drive shaft gearwheel is arranged coaxially on the drive shaft. The drive shaft gearwheel establishes the drive connection to the second press element driven part. The drive shaft gearwheel accordingly generally engages with a second press element gearwheel assigned thereto. It can in particular be designed as a bevel gear, although a design as a spur gear or crown gear is also conceivable.

The first press element driven part can in particular be provided to at least indirectly drive a press roller in a feed area of the press chamber, and the second press element driven part can in particular be provided to at least indirectly drive an endless circumferentially drivable press element. The pressing roller, which forms a first press element here, can in particular be designed as a starter roller. The pressing roller acts directly on the crop. The pressing roller can define a feed gap on one side through which the crop enters the press chamber. In the assembled state, the movement of the first press element driven part is transmitted directly or indirectly to the pressing roller. In this embodiment, the second press element is an endless press element that can be driven in rotation relative to the frame of the round baler. Such a press element can consist of one or more components. The press element is guided via a plurality of guide rollers or tension rollers, at least one of which can be driven via the second press element driven part and can therefore be described as a drive roller. The press element can be designed as an endless chain rod belt. It would also be conceivable for the press element to have a plurality of separate pressing belts running side by side. The press element can in particular be designed as a single pressing belt.

Various options are available with regard to the drive of the press roll. One embodiment provides for the first press element driven part to have a press roller gearwheel, which is provided for torsion-proof connection to a press roller and which interacts with the first coupling gearwheel, either directly or indirectly, via at least one intermediate gearwheel. The press roller gear thus corresponds to the first press element gearwheel. The first coupling gearwheel can engage directly with the press roller gearwheel, which is in turn arranged coaxially on the press roller. The power is then transmitted from the drive shaft to the press roller via just two gearwheels, which reduces the number of components required and also provides low wear. The first coupling gearwheel can alternatively also interact with the press roller gearwheel via at least one intermediate gearwheel. Overall, the power is transmitted to the first press element exclusively via interacting gearwheels, which results in low wear.

In an embodiment of the present invention, the conveying element output part can, for example, have a conveying element gearwheel which is provided for a non-rotating connection with the conveying element and which interacts with the second coupling gearwheel, cither directly or indirectly via at least one intermediate gearwheel. This means that when mounted, the conveying element gearwheel is connected to the conveying element so that it cannot rotate. The conveying element therefore rotates synchronously and coaxially therewith. The conveying element gearwheel either interacts directly with the second coupling gearwheel, i.e., the two gearwheels mesh with each other, or they interact indirectly via at least one intermediate gearwheel. They can in particular interact via exactly one intermediate gearwheel so that the direction of rotation of the conveying element gearwheel corresponds to that of the second coupling gearwheel. Several intermediate gearwheels can also be provided. Since the power is transmitted to the conveying element exclusively via interacting gearwheels, this embodiment also minimizes wear.

An embodiment of the present invention provides for the drive shaft gearwheel to interact with an input shaft gearwheel, through which the drive torque can be transmitted to the drive shaft. This means that the drive torque, which is usually generated by a motor, is transmitted to the drive shaft via the input shaft gearwheel and the drive shaft gearwheel. The input shaft gearwheel can in particular be connected to an input shaft so that it cannot rotate. This in turn can be directly or indirectly coupled to the motor in a force-transmitting manner. The drive shaft gearwheel can, for example, have a claw coupling via which the drive torque is transmitted from a tractor to the round baler. The input shaft can also be designed, for example, as a cardan shaft. If the drive torque is coupled via the input shaft gearwheel, which interacts with the drive shaft gearwheel, the force or torque can be transmitted to the second press element drive part entirely or partially through the drive shaft gearwheel. Under certain circumstances, this can reduce the load on the drive shaft or those parts that do not form the drive shaft gear. The input shaft gearwheel and, if applicable, the input shaft can be regarded as elements of the drive part.

The present invention furthermore provides that the first coupling gear can, for example, be preloaded by a coupling spring element in the direction of the coupling position. The coupling spring element acts directly or indirectly between the drive shaft and the coupling gearwheel. The coupling spring element acts on the coupling gearwheel, possibly via at least one intermediate element or directly, in the direction of the coupling position. Provided that no other forces counteract the tension of the spring element, the coupling gearwheel therefore adopts the coupling position. This means that the coupling gearwheel remains in the coupling position or moves into the coupling position. The state in which the feed element driven part is coupled thus corresponds to a rest position or a normal state. The spring element is elastic and generates a restoring force when deflected from the coupling position. The spring element can be designed as a coil spring, for example, which surrounds the drive shaft.

The transmission unit can, for example, have a switch mechanism with at least one shift element that can be adjusted between a passive position and an active position and, when adjusted to the active position, engages axially laterally on the first coupling gearwheel and adjusts the first coupling gearwheel to the release position. The shift element therefore at least causes the first coupling gearwheel to be moved into the release position. The opposite adjustment into the coupling position can either also be generated by the shift element or, for example, by the above-mentioned coupling spring element. The terms “active position” and “passive position” indicate that the shift element “actively” causes the first coupling gearwheel to move into the release position. These designations should otherwise, however, not be interpreted restrictively. The shift element acts laterally on the first coupling gearwheel in the axial direction with respect to the drive shaft axis of rotation. At least one force component acts on the coupling gearwheel in the axial direction and causes its axial displacement. A restoring force of the coupling spring element must be overcome under certain circumstances. It is conceivable that in the operating state, the drive shaft rotates with the first coupling gearwheel while the shift element is acting. A frictional force can in this case in particular be reduced by the shift element interacting with the first coupling gearwheel via at least one rolling bearing. The rolling bearing can be connected to the shift element and its rolling elements can roll on the axially lateral surface of the first coupling gearwheel.

The shift element can, for example, be adjusted between the active position and the passive position by pivoting about a shift element pivot axis and engages with at least one switching section spaced from the shift element pivot axis on the first coupling gearwheel. A pivot bearing required for pivoting is generally easier to implement than a linear bearing or a linear guide, which would be necessary for translational adjustment. The respective switching section is at a distance from the shift element pivot axis and therefore moves in an arc when adjusting between the active position and the passive position. The swivel angle required to achieve the intended displacement of the first coupling gearwheel can be determined in particular by selecting the appropriate radial distance of the switching section from the shift element swivel axis. In order to prevent an uneven load on the first coupling gearwheel, the shift element can, for example, be designed as a shift fork and has two spaced shift sections. The two shifting sections can then engage in different areas of the first coupling gearwheel, in particular in areas that are opposite each other with respect to the drive shaft axis of rotation. The at least one shifting section can, for example, have a rolling bearing via which it engages with the coupling gearwheel.

In an embodiment of the present invention, the shift element can, for example, be adjusted directly, i.e., actuator-actuated, or manually. In an embodiment of the present invention, the switch mechanism can, for example, have an actuating element that is set up to actuate the shift element in order to move it to the active position. The actuating element can in this case therefore be adjusted, whereby the shift element is moved to the active position as a result. The reverse adjustment to the passive position can also be generated by the actuating element or alternatively by a switching spring element which biases the shift element towards the passive position. Various advantages can be achieved by indirect actuation via the actuating element. The actuating element can, for example, be more accessible than the shift element. It is also possible to achieve a transmission ratio through the interaction of the actuating element and the shift element, which can be particularly advantageous when the switching mechanism is operated manually.

In an embodiment of the present invention, the actuating element can, for example, be pivotable about an actuating element pivot axis and has an eccentric section which interacts with an actuating section of the shift element, which is spaced apart from the switching element pivot axis and from the at least one switching section. The eccentric section is generally not symmetrical to the actuating element pivot axis. The eccentric section can, for example, project radially in a limited area. If the eccentric section is rotated in the direction of the actuating section, this leads to a deflection of the actuating section and thus of the entire shift element. The actuating section of the shift element is at a distance from the switching element pivot axis so that the eccentric section can exert a torque on the shift element via the actuating section. The actuating section is also spaced from the switching section or switching sections. It can be axially, radially and/or tangentially offset relative to the at least one switching section (with respect to the switching element pivot axis). It can in particular be offset by at least 90° or at least 150° relative to the at least one switching section. These sections can thus be located on opposite sides of the switching element pivot axis, which may be advantageous in terms of installation space. A radially different arrangement can achieve a kind of transmission so that, for example, a force acting on the eccentric section can be amplified or a deflection caused by the eccentric section can be increased. The shape of the eccentric section and the actuating section and their arrangement in relation to each other can, for example, be coordinated so that the actuating section initially interacts with the eccentric section relatively close to the actuator pivot axis in the passive position or in its vicinity. This means that a torque generated in the actuating element results in a comparatively large force on the actuating section. This can be advantageous to overcome an initially prevailing static friction which opposes a movement of the first coupling gearwheel. Once a transition from static friction to sliding friction has taken place, a lower force is sufficient so that the contact area between the eccentric section and the actuating section can be moved further away from the actuating element pivot axis. A simple sliding connection between the eccentric section and the actuating section is normally sufficient, but a connection via a rolling bearing or a single rolling element could here also be provided.

Various configurations of the actuating element are conceivable. If the coupling mechanism is to be actuated by an actuator, the actuating element can be designed for connection to a corresponding actuator. If a manual adjustment of the coupling mechanism is intended, the actuating element can, for example, have a drive profile arranged outside a gearbox housing for a positive engagement with a tool. The drive profile can, for example, be designed as an internal hexagon, external hexagon, square or similar. It is designed to complement the tool with which it can be operated, normally a wrench or screwdriver. Since the drive profile must be accessible to the user, it is arranged outside the gearbox housing, whereby other parts of the actuating element, in particular the eccentric section, as well as the shift element can, for example, be arranged inside the gearbox housing.

The present invention also provides a round baler having a frame, a press element which can be driven relative to the frame which is designed to act on crop material in a press chamber, a feed element which can be driven relative to the frame and which is designed to convey crop material towards the press chamber, and with a transmission unit according to the present invention, wherein the press element driven part is coupled at least indirectly to the press element in a driving manner and the feed element driven part is coupled at least indirectly to the feed element in a driving manner.

The aforementioned terms were explained with reference to the transmission unit according to the present invention and are therefore not explained again. Advantageous embodiments of the round baler according to the present invention correspond to those of the transmission unit according to the present invention.

The present invention is described in greater below with reference to drawings. The drawings are merely exemplary and do not thereby limit the general idea of the present invention.

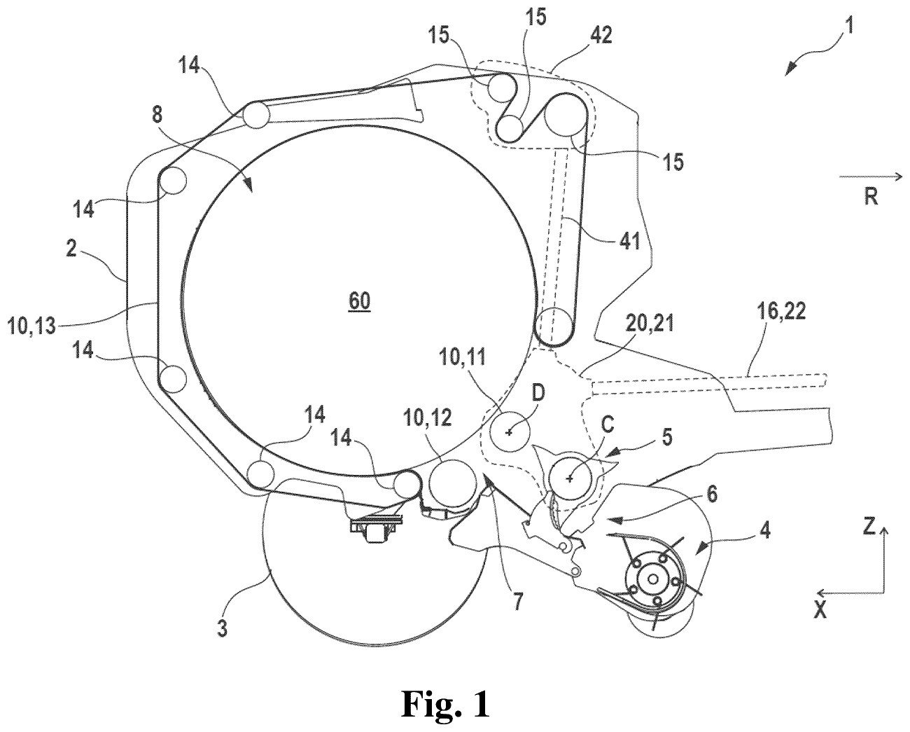

FIG. 1 shows a round baler 1 according to the present invention with a transmission unit 20 according to the present invention. A longitudinal axis X, a transverse axis Y and a vertical axis Z of the round baler 1 are shown in the drawings. The round baler 1 is intended to be pulled by a tractor or a tractor unit (not shown). Apart from running wheels 3, on which the round baler 1 stands, a pressing device 10 is arranged on a frame 2 of the round baler 1, which can form a pressing chamber 8 of variable size for forming a crop bale 60. The crop, such as straw, hay or grass, is picked up from the ground by a pick-up 4 arranged at the front of the frame 2 in the direction of travel R and passes on to a cutting rotor 5, which acts as a feed element. The cutting rotor 5 grips the crop, cuts it up, and transports the crop further against the direction of travel R and through a conveyor channel 6 towards a feed area 7 of the pressing chamber 8. A simple conveyor rotor can also be provided instead of the cutting rotor 5.

In this case, the pressing device 10 has a pressing roller 11, which serves as the first press element, a starter roller 12 opposite thereto, and a pressing belt 13 acting as the second press element, which together define the pressing chamber 8. The pressing roller 11 and the pressing belt 13 cause the crop bale 60 to rotate and simultaneously compress the crop. The pressing belt 13 is guided by a plurality of rotatably mounted guide rollers 14 and drive rollers 15 and is kept under tension thereby. While the guide rollers 14 are purely passively rotatable relative to the frame, the drive rollers 15 are actively drivable and serve to set the pressing belt 13 into a rotating movement.

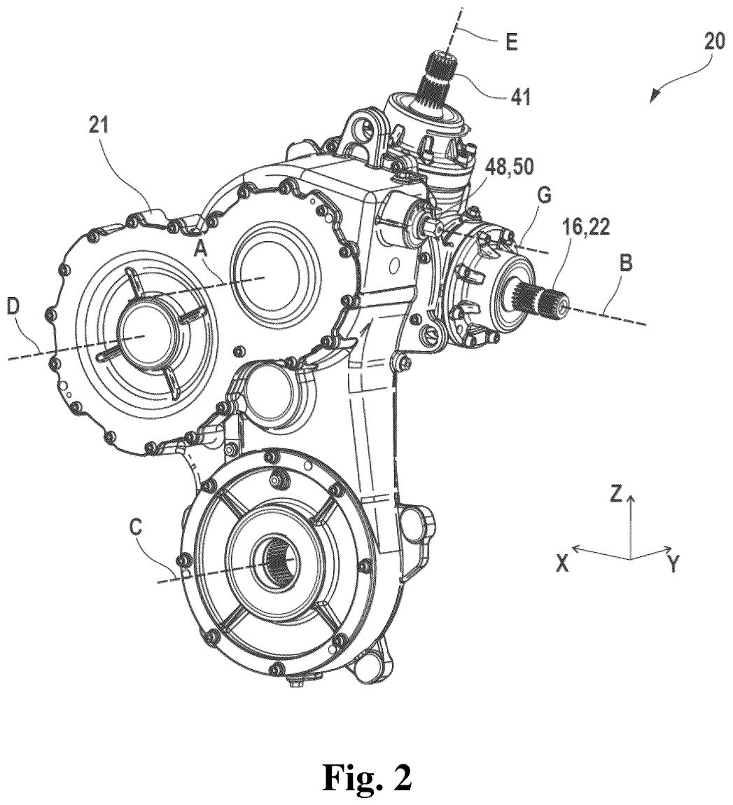

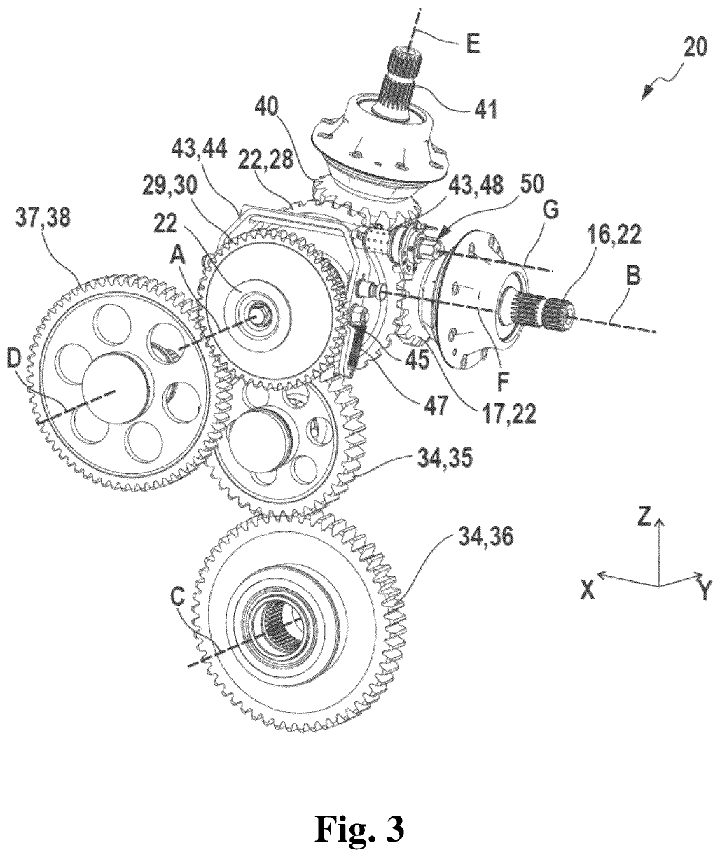

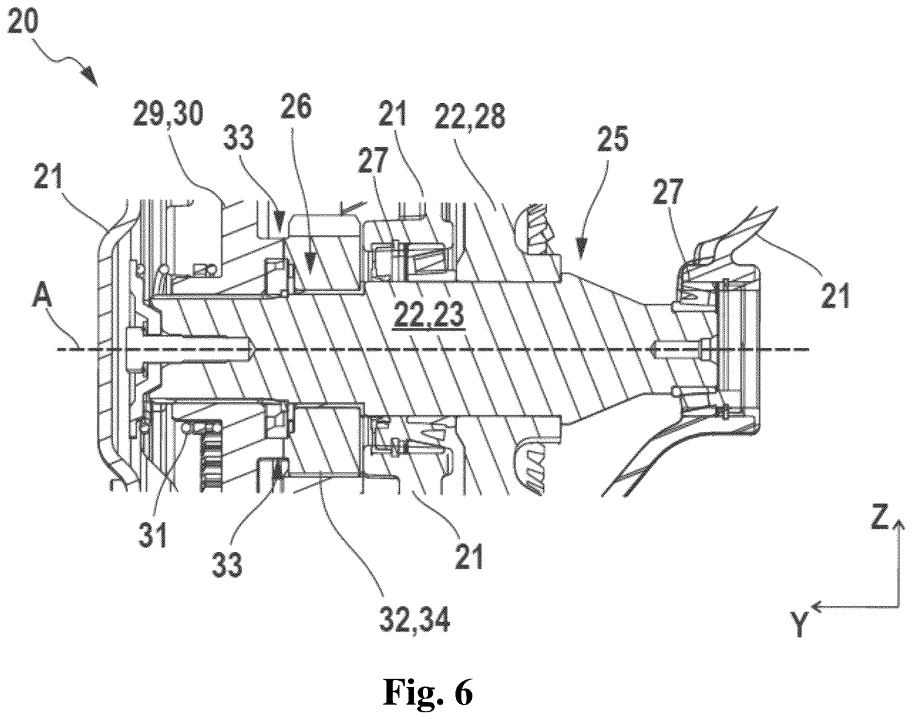

The round baler 1 shown here does not have its own drive motor. All drive power is transferred from the tractor. In this case, the pick-up 4 is driven hydraulically, for which purpose the round baler 1 is connected to the tractor with a hydraulic line (that is not shown). The drive power for the cutting rotor 5, the pressing roller 11, the starter roller 12, and the pressing belt 13, is transmitted mechanically by the tractor. An input shaft 16 shown schematically in FIG. 1, which is designed as a PTO shaft, is connected to a PTO shaft of the tractor therefore. The input shaft 16 leads to the transmission unit 20, which is only indicated in FIG. 1 and which shown in detail in FIGS. 2 to 6. An input shaft gearwheel 17, which is non-rotatably connected to the input shaft 16, meshes with a drive shaft gearwheel 28, which in turn is non-rotatably connected to a drive shaft 23. The aforementioned gearwheels 17, 28 are designed as bevel gears. The drive shaft 23 forms a central element of a drive part 22 of the transmission unit 20. The input shaft 16, the input shaft gearwheel 17, and the drive shaft gearwheel 28 can also be regarded as elements of the drive part 22. The input shaft 16 is mounted on the transmission housing 21 via two roller bearings 27 (shown in FIG. 6) so that the input shaft 16 can rotate about a drive shaft axis of rotation A, which in this case runs parallel to the transverse axis Y. The input shaft 16 is rotatable about an input shaft axis of rotation B extending perpendicular to the drive shaft axis of rotation A. While the drive shaft gearwheel 28 is rigidly connected to the drive shaft 23, two coupling gearwheels 30, 32 are movably arranged on the drive shaft 23. While the drive shaft gearwheel 28 is arranged in a bearing section 25 of the drive shaft 23 between the roller bearings 27, the coupling gearwheels 30, 32 are arranged in a cantilevered section 26.

A first coupling gearwheel 30, which is designed as a spur gear, is non-rotatably connected to the drive shaft 23, but is axially displaceable with respect to the drive shaft axis of rotation A. A second coupling gearwheel 32, which is arranged closer to the bearing section 25, is fixed axially on the drive shaft 23, but is freely rotatable relative thereto. The first coupling gearwheel 30 meshes with a press roller gearwheel 38, which is non-rotatably connected to the pressing roller 11. The press roller gearwheel 38 belongs to a press roller driven part 37 of the transmission unit 20, which can also be referred to as the first press element driven part. The pressing roller 11 is coupled to the starter roller 12 by a chain drive (which is not shown). The second coupling gearwheel 32 meshes with an intermediate gearwheel 35, which in turn meshes with a cutting rotor gearwheel 36, which is non-rotatably connected to the cutting rotor 5. The second coupling gearwheel 32, the intermediate gearwheel 35, and the cutting rotor gearwheel 36 belong to a cutting rotor driven part 34, which can also be referred to as the feed element output shaft. The gearwheels 30, 32, 35, 36, 38 mentioned here are all designed as spur gears.

The drive shaft gearwheel 28 meshes with a connecting shaft gearwheel 40, which is also designed as a bevel gear and is seated on an upwardly extending connecting shaft 41. This is rotatable about a connecting shaft axis of rotation E running perpendicular to the drive shaft axis of rotation A and establishes a connection to a drive roller gear 42, via which the drive rollers 15 can be driven. The connecting shaft gearwheel 40 belongs to a press belt driven part 39 of the transmission unit 20, which can also be referred to as the second press element driven part.

While the drive part 22 is permanently coupled to the press roller driven part 37 and the press belt driven part 39, the coupling between the drive part 22 and the cutting rotor driven part 34 depends on the position of the first coupling gearwheel 30. In the normal operating state of the round baler 1, the first coupling gearwheel 30 is arranged in a coupling position in which it engages with the second coupling gearwheel 32 via a claw coupling 33. The positive locking of the claw coupling 33 connects the second coupling gearwheel 32 in a non-rotatable manner to the first coupling gearwheel 30 and thus also to the drive shaft 23. The movement of the pressing roller 11, the pressing belt 13, and the cutting rotor 5 are accordingly coupled to each other via the transmission unit 20.

In the event of a blockage of the cutting rotor 5, for example, due to a crop jam or a foreign object being picked up, it makes sense to stop the drive of the round baler 1 and to move the cutting rotor 5 manually against its normal direction of rotation in order to be able to clear the blockage. To prevent the pressing belt 13 and the pressing roller 11 from also having to be moved, the cutting rotor driven part 34 is decoupled from the drive part 22. The first coupling gearwheel 30 is moved axially away from the second coupling gearwheel 32 into a release position so that the positive locking via the claw coupling 33 is canceled. The second coupling gearwheel 32 and the drive shaft 23 are then free to rotate relative to each other. The press roller gearwheel 38 is designed with such a width that the first coupling gearwheel 30 remains engaged with the press roller gearwheel 38 during the entire displacement and also when the release position is reached.

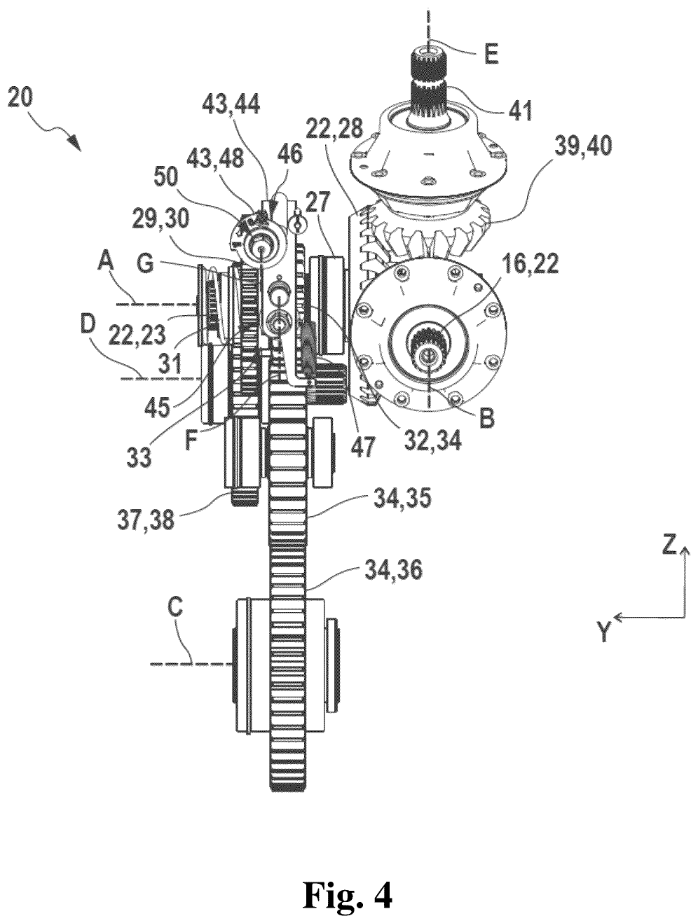

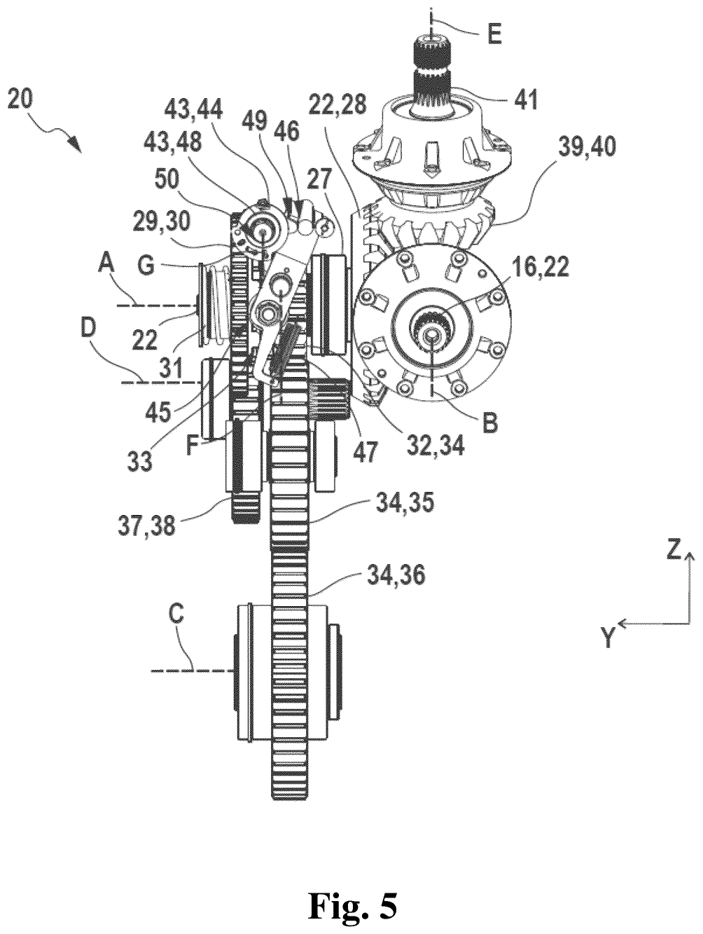

If no further axial forces act on the first coupling gearwheel 30, the first coupling gearwheel 30 is pushed into the coupling position or held in this position by a coupling spring element 31, which surrounds the drive shaft 23 as a coil spring. In order to move the first coupling gearwheel 30 into the release position, a user can use a switch mechanism 43. The switch mechanism 43 has a shift fork 44 serving as a shift element and an actuating element 48. The shift fork 44 is pivotable relative to the transmission housing 21 about a shift fork pivot axis F which extends perpendicular to the drive shaft pivot axis A, while the actuating element is pivotable about an actuating element pivot axis G which is also perpendicular to the drive shaft pivot axis A. The shift fork 44 has two shift sections 45, with which it can engage axially laterally on the first coupling gearwheel 30 in order to shift it into the release position. In order to reduce friction, each shift section 45 has a ball bearing (without reference sign). An adjusting section 46 is formed opposite the shifting sections 45 with respect to the shifting fork pivot axis F. The actuating element 48 has an eccentric section 49, which can interact with the adjusting section 46 in order to move the shift fork 44 from a passive position shown in FIG. 4 to an active position shown in FIG. 5. When adjusting, i.e., pivoting, the shift fork 44 from the passive position to the active position, the shift sections 45 act axially laterally on the first coupling gearwheel 30 and press the first coupling gearwheel 30 into the release position against the force of the coupling spring element 31.

Without the action of the actuating element 48, the shift fork 44 is held in the passive position by a shift spring element 47, which is connected to the transmission housing 21 (in a manner not shown here in detail). If the adjusting element 48 is rotated, however, the eccentric section 49 exerts a force on the adjusting section 46 and thus a torque on the shift fork 44. The shape and position of the eccentric section 49 and the adjusting section 46 are matched to each other so that, starting from the passive position of the shift fork 44, the adjusting section 46 initially interacts with the eccentric section 49 comparatively close to the actuating element pivot axis G. A given torque in the actuating element 48 accordingly initially results in a relatively large force on the adjusting section 46 and thus also a relatively large force on the first coupling gearwheel 30. This serves to overcome an initial static friction between the first coupling gearwheel 30 and the drive shaft 23. As the rotation of the actuating element 48 progresses, the contact point to the adjusting section 46 moves away from the actuating element pivot axis G so that a lower force results but a greater displacement path can be achieved. The actuating element 48 has a drive profile 50, in this case an external hexagonal profile, which is accessible from outside the transmission housing 21. The user can act on the drive profile 50 with a suitable wrench and thereby effect the adjustment of the actuating element 48, which results in the adjustment of the shift fork 44 into the active position and the adjustment of the first coupling gearwheel 30 into the release position. When the user again resets the actuating element, the shift fork 44 and the first coupling gearwheel 30 return to the passive position and the coupling position due to the preload from the spring elements 31, 47.

The present invention is not limited to embodiments described herein; reference should be had to the appended claims.

### LIST OF REFERENCE CHARACTERS

1 Round baler
2 Frame
3 Wheel
4 Pick-up
5 Cutting rotor
6 Conveyor channel
7 Feed area
8 Pressing chamber
10 Pressing device
11 Pressing roller
12 Starter roller
13 Pressing belt
14 Guide roller
15 Drive roller
16 Input shaft
17 Input shaft gearwheel
20 Transmission unit
21 Transmission housing
22 Drive part
23 Drive shaft
25 Bearing section
26 Cantilevered section
27 Roller bearing
28 Drive shaft gearwheel
29 Coupling mechanism
30 First coupling gearwheel
31 Coupling spring element
32 Second coupling gearwheel
33 Claw coupling
34 Cutting rotor driven part
35 Intermediate gearwheel
36 Cutting rotor gearwheel
37 Press roller driven part
38 Press roller gearwheel
39 Press belt driven part
40 Connecting shaft gearwheel
41 Connecting shaft
42 Drive roller gear
43 Switch mechanism
44 Shift fork
45 Shift section
46 Adjusting section
47 Shift spring element
48 Actuating element
49 Eccentric section
50 Drive profile
60 Crop bale
A Drive shaft pivot axis
B Input shaft axis of rotation
C Cutting rotor gearwheel axis of rotation
D Press roller gearwheel axis of rotation
E Connecting shaft axis of rotation
F Shifting fork pivot axis
G actuating element pivot axis
R Direction of travel
X Longitudinal axis
Y Traverse axis
Z Vertical axis

What is claimed is:

1-15. (canceled)

16. A transmission unit for a round baler, the transmission unit comprising:
a drive part comprising a drive shaft which is configured to couple in a drive torque, the drive shaft being rotatable about a drive shaft axis of rotation;
a press roller driven part which is configured to have the drive part be coupled thereto in a driving manner and to at least indirectly drive a pressing roller so as to act on a crop material in a pressing chamber;
a cutting rotor driven part which is configured to at least indirectly drive a cutting rotor so as to convey the crop material towards the pressing chamber; and
a coupling mechanism which is configured to selectively couple and decouple the drive part and the cutting rotor driven part,
wherein
the coupling mechanism comprises a first coupling gearwheel which is non-rotatably connected to the drive shaft and which is configured to be adjustable axially with respect thereto, the first coupling gearwheel being configured so as to be,
selectively drivingly coupled to the cutting rotor driven part in a coupling position and to be decoupled from the cutting rotor driven part in a release position, and
drivingly coupled to the press roller driven part both in the coupling position and in the release position.

17. The transmission unit as recited in claim 16, wherein,
the cutting rotor driven part comprises a second coupling gearwheel which coaxially surrounds the drive shaft, and
the first coupling gearwheel, in the coupling position, is further configured to non-rotatably connect the second coupling gearwheel to the drive shaft via a positive fit with the second coupling gearwheel, while the second coupling gearwheel is freely rotatable relative to the drive shaft via a release of the positive fit in the release position.

18. The transmission unit as recited claim 17, further comprising:
a transmission housing for a stationary arrangement on the round baler,
wherein,
the drive shaft comprises a bearing section, the bearing section being rotatably mounted on the transmission housing, and a cantilevered section, and
the first coupling gearwheel and the second coupling gearwheel are each arranged on the cantilevered section.

19. The transmission unit as recited claim 17, further comprising:
a press belt driven part; and
a drive shaft gearwheel which is non-rotatably connected to the drive shaft and which is drivingly coupled to the press belt driven part,
wherein,
the first coupling gearwheel is drivingly coupled to the press roller driven part.

20. The transmission unit as recited claim 19, further comprising:
an input shaft gearwheel via which a drive torque is transmittable to the drive shaft,
wherein,
the drive shaft gearwheel is configured to interact with the input shaft gearwheel.

21. The transmission unit as recited claim 19, wherein,
the press roller driven part is configured to at least indirectly drive the pressing roller in a feed area of the pressing chamber, and
the press belt driven part is configured to at least indirectly drive a pressing belt which is configured to be driven circumferentially.

22. The transmission unit as recited claim 21, wherein the press roller driven part comprises a press roll gearwheel which is configured to provide a torsion-proof connection to the pressing roller and to interact, either directly or indirectly, via at least one intermediate gear, with the first coupling gearwheel.

23. The transmission unit as recited claim 17, wherein the cutting rotor driven part further comprises a cutting rotor gearwheel which is configured to non-rotatably connect to the cutting rotor and to interact, either directly or indirectly, via at least one intermediate gearwheel, with the second coupling gearwheel.

24. The transmission unit as recited in claim 16, further comprising:
a coupling spring element which is configured to preload the first coupling gearwheel in a direction of the coupling position.

25. The transmission unit as recited in claim 16, further comprising:
a switch mechanism which comprises at least one shift element,
wherein,
the at least one shift element is configured to be adjustable between a passive position and an active position and, when the at least one shift element is adjusted to the active position, to engage axially laterally on the first coupling gearwheel so as to adjust the first coupling gearwheel to the release position.

26. The transmission unit as recited in claim 25, wherein the at least one shift element is adjustable between the active position and the passive position by pivoting about a shift element pivot axis so as to engage with at least one shift section which is spaced from the shift element pivot axis on the first coupling gearwheel.

27. The transmission unit as recited in claim 26, wherein the switch mechanism further comprises an actuating element which is configured to act on the at least one shift element so as to move the at least one shift element into the active position.

28. The transmission unit as recited in claim 27, wherein,
the actuating element is pivotable about an actuating element pivot axis and comprises an eccentric section which is configured to interact with an actuating section of the at least one shifting element, and
the actuating section is spaced apart from the shifting element pivot axis and from the at least one shifting section.

29. The transmission unit as recited in claim 27, wherein the actuating element further comprise a drive profile which is arranged outside a transmission housing for a positive engagement with a tool.

30. A round baler comprising:
a frame;
a press element which is configured to be driven relative to the frame and to act on a harvested material in a pressing chamber;
a cutting rotor which is configured to be driven relative to the frame and to convey the harvested material towards the pressing chamber; and
the transmission unit as recited in claim 16,
wherein,
the press roller driven part is coupled at least indirectly driving to the press element, and
the cutting rotor driven part is coupled at least indirectly driving to the cutting rotor.
